(19) United States
(12) Patent Application Publication
(10) Pub. No.: US 2021/0386245 A1
(43) Pub. Date: Dec. 16, 2021

(54) COFFEE SYSTEM AND METHOD

(71) Applicant: Ricconics LLC, Charlotte, NC (US)

(72) Inventor: Roderick M. Dayton, Charlotte, NC (US)

(21) Appl. No.: 17/232,092

(22) Filed: Apr. 15, 2021

Related U.S. Application Data
(63) Continuation of application No. PCT/US2020/037827, filed on Jun. 15, 2020.

(51) Int. Cl. A47J 42/40; A47J 31/52; A47J 31/42; A47J 31/44; A47J 42/50; A47J 42/44; A47J 31/00; A23F 5/10; A23F 5/26; G06Q 10/06; G06Q 20/20; G06Q 20/32; G05B 15/02

(52) U.S. Cl. CPC A47J 42/40; A47J 31/525; A47J 31/42; A47J 31/4492; A47J 42/50; A47J 42/44; G06Q 50/12; A23F 5/105; A23F 5/262; G06Q 10/06315; G06Q 20/202; G06Q 20/322; G05B 15/02; A47J 31/007

(57) ABSTRACT

An apparatus for preparing coffee grounds for a coffee brewing process includes a control system that receives a coffee order. The coffee order includes information indicative of a composition of coffee beans ordered, and a quantity of the coffee beans to be included in the composition. A metering device receives the coffee beans from a hopper assembly, and is controlled by the control system to: measure the quantity of the coffee beans to be included in the composition, and output the quantity of the coffee beans measured from an outlet aperture. An inlet aperture of a grinder receives the measured quantity of the coffee beans output through the outlet aperture of the metering device and grinds the coffee beans to produce ground coffee. A nozzle is arranged to introduce moisture to the ground coffee output by the grinder, producing ground and moistened coffee that is dispensed for brewing coffee in fulfillment of the coffee order.

### BACKGROUND OF THE INVENTION

### 1. Field of the Invention

This application relates generally to a method and apparatus for preparing coffee and, more specifically, to a method and apparatus for selectively preparing coffee beans, on demand, for a coffee brewing process.

### 2. Description of Related Art

Consumers wishing to order coffee at a cafe, are typically presented with several different coffees selected by the café to be served that day. Examples of the coffee offerings commonly include drip coffee, pour over coffee, and espresso coffee drinks.

Drip coffee, for example, is commonly brewed ahead of time, stored in an insulated carafe, and simply dispensed when the coffee is ordered. To prepare drip coffee, a barista prepares a large filter with enough ground coffee to make several cups (e.g., at least 8, or at least 10, or a much greater number) of coffee. A large volume of water is distributed over the ground coffee beans to prepare a pot of coffee that may be stored in an insulated carafe, from which many individual cups of coffee are poured. Many consumers can be served with drip coffee by baristas in an efficient manner because a cup of drip coffee is quickly prepared simply by pouring or otherwise dispensing an individual cup from the carafe.

However, due to the volume of coffee in each carafe, café s typically offer only a few (e.g., two or three) types of drip coffee for purchase at any given time. Further, café s often use pre-ground coffee beans (e.g., ground, then packaged and sold to the café well before the beginning of the process to prepare a pot of drip coffee has begun, or even before being delivered to the café) to quickly prepare drip coffee, without a significant expenditure of labor. But pre-ground coffee degrades over time, and may result in pots of brewed coffee with an undesirable taste. Drip coffee machines also typically prevent baristas from manually controlling aspects of the brewing process (e.g., performing pre-infusion of the coffee during brewing) to improve taste of drip coffee. And even drip coffee machines that can perform a pre-infusion step, typically only affect a small portion (e.g., only the grinds on top) of the ground coffee beans in the filter.

More recently, preparing individual cups of coffee using a so-called “pour over” method has become common at café s. The pour over method involves preparing a relatively-small filter for an individual cup of coffee, instead of a relatively-large filter prepared for a full pot of drip coffee. A quantity of ground beans suitable for a single cup (or two cups, or a plurality of cups, but less than a pot) is placed in the filter, and a corresponding volume of hot water is manually poured from a tea pot over the ground beans.

Since a large pot of coffee is not brewed using the pour over method, there may be more pour-over options available than drip-coffee options. But consumers are again typically limited to a small number of individual coffee options that baristas at the café have designated as being available for purchase as a pour over coffee that day. To avoid lengthy delays resulting from such a process, the available coffee beans may also be pre-ground (i.e., ground prior to an order for a pour over coffee being placed by a consumer), resulting in the undesirable taste mentioned above. Grinding the beans when orders are placed further increases the amount of time required to brew a cup of coffee using the pour over method, leading to consumer dissatisfaction at the long wait time for a pour over coffee.

The process of roasting coffee beans also limits when the roasted coffee can be packaged and shipped, and/or when coffee beans roasted in-house can be used to brew coffee. Roasted coffee emits carbon dioxide and/or other gasses over a period of time after the roasting process is complete. Emissions from roasted coffee, in whole bean or ground coffee, enclosed in a sealed package can cause the sealed package to burst open if the coffee is packaged too soon after being roasted. A valve can be installed in the bag or other package to allow the gas emissions to escape, avoiding the formation of an airtight seal of the package, which prevents the package from breaking open as a result of building pressure within the package. However, the valve can form a costly portion of the package, and constitutes a weak point of the package through which outside air can possibly enter the package. Since the package is not airtight, the flavor profile of the coffee can degrade over time, limiting the shelf life of the packaged coffee. And roasters who roast coffee in-house for immediate use risk grinding the coffee beans and brewing coffee to be served to customers before adequate emission of the retained carbon dioxide and/or other gasses has occurred, which negatively impacts the taste of the coffee products.

### BRIEF SUMMARY OF THE INVENTION

Accordingly, there is a need in the art for an apparatus, system and method for efficiently producing personalized ground coffee for a coffee brewing process. The present technology can prepare a desired quantity of coffee beans, optionally including a personalized blend of a plurality of different types of coffee beans. The selected beans are ground, on demand, and subjected to an accelerated degassing process before being dispensed.

For example, the present system and method can involve receiving an order specifying at least one, and optionally a plurality of different coffee beans. A suitable quantity of the ordered bean(s) can be measured from one or more hoppers by a metering device, which can be plumbed into a grinding system. The measured quantity of coffee beans from the metering device is deposited by the metering device into an inlet of a grinding system. The combined coffee beans in the grinding system are ground to a suitable fineness for a defined brewing method.

The present apparatus also includes a nozzle for introducing moisture to the ground coffee beans, which are supplied to an inlet of a vacuum chamber. A substantial portion (e.g., at least 15% by weight, at least 25% by weight, at least 50% by weight, at least 75% by weight, etc.) of the ground coffee is exposed to moisture supplied by the nozzle.

The ground coffee exposed to the moisture is introduced to a vacuum chamber, where the ground and moist coffee is exposed to a sub-atmospheric (e.g., less than 1 atm.) pressure. The sub-atmospheric pressure can optionally be repeatedly established and released, in pulses. For example, the ground and moist coffee can be exposed to a sub-atmospheric pressure, and then returned to an ambient pressure of the present system (e.g., 1 atm., with variations accounting to changes in altitude, for example). Establishing and releasing the sub-atmospheric pressure can be repeated a plurality of times over a defined period, such as at least ten (10 sec.) seconds, at least twenty (20 sec.) seconds, at least thirty (30 sec.) seconds, at least one (1 min.) minute, etc.

The nozzle can optionally be positioned and configured as part of the system to introduce the moisture to ground coffee between the grinding system and the vacuum chamber. For such embodiments, the moisture can be introduced by the nozzle as a fine mist, through which the ground coffee passes en route to the vacuum chamber. A plunger can be provided to urge at least a portion of the ground and moist coffee into the vacuum chamber, after having been exposed to the moisture produced by the nozzle. For example, the plunger can include a wiper that scrapes ground and moist coffee adhered to a wall or other surface of a conduit into the vacuum chamber. According to alternate embodiments, the plunger can be provided and controlled to urge at least a portion of the ground and moist coffee out of the vacuum chamber, after having been exposed to the sub-atmospheric pressure within the vacuum chamber.

Exposing the ground and moist coffee to the sub-atmospheric pressure within the vacuum chamber is believed to accelerate a degassing process of the ground coffee. Degassing involves removing at least a portion of gaseous components such as carbon dioxide released from the coffee beans as a result of grinding, for example, that may contribute to an undesirable taste of the brewed coffee. Unlike pre-infusion, which is performed on ground coffee already in a filter as part of the brewing process by pouring a small quantity of the hot water used for brewing onto the grounds, the present technology degasses a greater portion of the ground coffee.

According to one aspect, the subject application involves an apparatus for preparing coffee grounds for a coffee brewing process includes a control system that receives a coffee order. The coffee order includes information indicative of a composition of coffee beans ordered, and a quantity of the coffee beans to be included in the composition. A metering device receives the coffee beans from a hopper assembly, and is controlled by the control system to: measure the quantity of the coffee beans to be included in the composition, and output the quantity of the coffee beans measured from an outlet aperture. An inlet aperture of a grinder receives the measured quantity of the coffee beans output through the outlet aperture of the metering device and grinds the coffee beans to produce ground coffee. A nozzle is arranged to introduce moisture to the ground coffee output by the grinder, producing ground and moistened coffee that is dispensed for brewing coffee in fulfillment of the coffee order.

According to another aspect, the subject application involves an apparatus for preparing coffee beans for a coffee brewing process. The apparatus includes a control system that receives a coffee order. The coffee order includes information indicative of a composition of whole coffee beans ordered, and a quantity of the whole coffee beans to be included in the composition. A metering device that receives the whole coffee beans from a hopper assembly is controlled by the control system to: measure the quantity of the whole coffee beans to be included in the composition, and output the quantity of the whole coffee beans measured from an outlet aperture. A nozzle introduces moisture to the whole coffee beans measured by the metering device, producing moistened coffee beans. A degassifier exposes the moistened coffee beans to a sub-atmospheric pressure after the moisture has been introduced to the whole coffee beans, accelerating degasification of the moistened coffee beans to produce degassed whole coffee beans. A dispenser discharges the degassed whole coffee beans to be transferred to a packaging system to be packaged for retail and/or wholesale distribution as degassed packaged coffee.

According to another aspect, the degassifier can optionally extract a sufficient quantity of gas from the moistened coffee beans so the degassed whole coffee beans are discharged from the dispenser in a condition suitable for packaging in an airtight container that lacks a valve allowing gas to escape the container.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an embodiment of a system for fulfilling personalized coffee orders in communication, over a communication network, with a plurality of electronic devices that submit personalized coffee orders;

FIG. 2 shows a partially cutaway view of an apparatus for preparing coffee grounds for a personalized coffee brewing process;

FIG. 3 shows an illustrative embodiment of a dispensing wheel for measuring quantities of coffee beans to be included in a coffee composition;

FIG. 4 shows a perspective view of a grinder and a degassifier of an apparatus for preparing coffee grounds for a personalized coffee brewing process;

FIG. 5 shows a multi-brew-head embodiment of a dispenser for providing degassed coffee to a receptacle used during a coffee brewing process;

FIG. 6 shows a graphical user interface that can be utilized to select a nearby café offering a personalized coffee ordering experience;

FIG. 7 shows a graphical user interface for specifying a coffee composition for a personalized coffee beverage;

FIG. 8 shows a focused view of a portion of a degassifier in which whole-bean or ground coffee is exposed to moisture before being introduced to a vacuum chamber; and

FIG. 9 is a top view of an embodiment of a rotor of a peristaltic pump that introduces measured quantities of water into a degassifier to increase a water content of coffee to be exposed to at least a partial vacuum.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

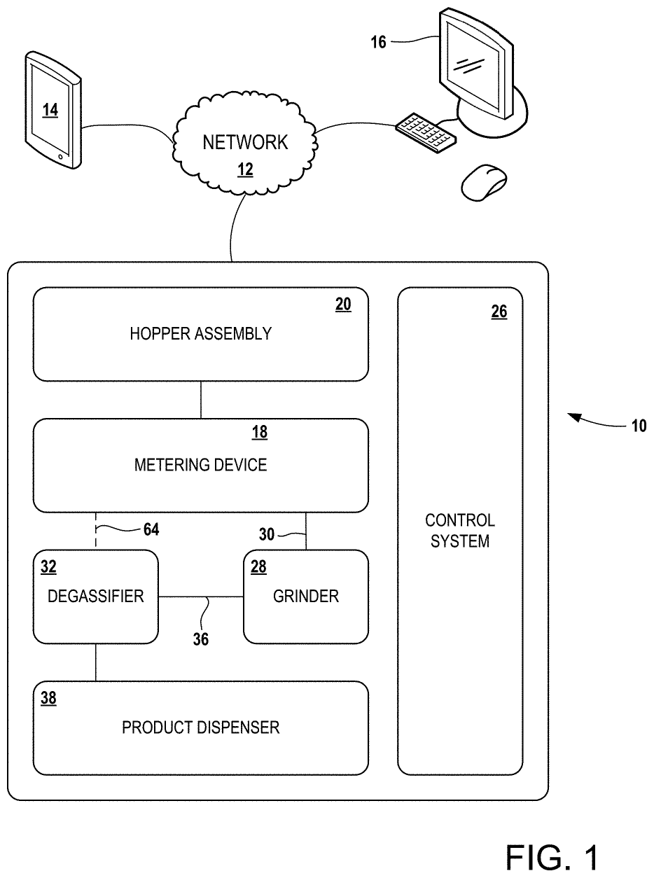

FIG. 1 shows an embodiment of an apparatus 10 for fulfilling personalized coffee orders by preparing coffee grounds for a coffee brewing process. The apparatus 10 is in communication with a plurality of electronic devices over a communication network 12. Embodiments of the electronic devices shown in FIG. 1 include, but are not limited to a portable cellular communication device 14 (e.g., a smartphone such as an Apple iPhone or Samsung Galaxy, for example, executing a coffee ordering app) and a point-of-sale terminal 16 used to complete a financial transaction for the sale of coffee in a café.

The portable cellular communication device 14, and optionally the point-of-sale terminal 16, transmit the personalized coffee orders input by respective users to the apparatus 10 over the communication network 12. The communication network 12 can include a wide area network such as the Internet, making use of public communication channels and cellular network hardware for example; a local area network, such as wired and/or wireless network switches, routers and other such devices; or any combination thereof. According to other embodiments, the point-of-sale terminal 16 can be directly connected to communicate with the apparatus 10, optionally without intervening network communication devices.

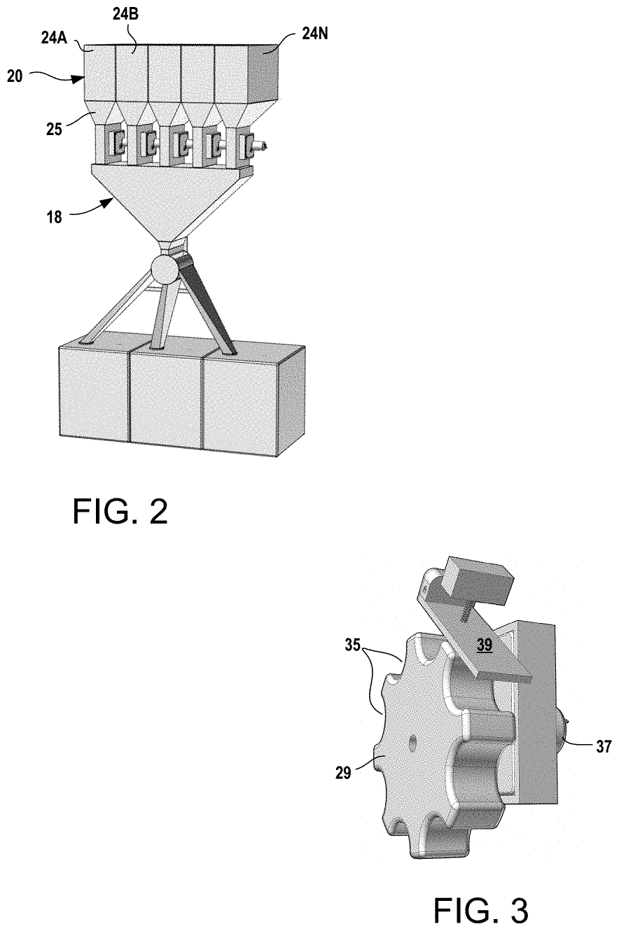

Shown schematically in FIG. 1, the illustrative embodiment of the apparatus 10 includes a metering device 18 that receives the ordered coffee beans from a hopper assembly 20. As described in greater detail below, the hopper assembly 20 can optionally include one, or a plurality of separate hoppers 24A, 24B, . . . , 24N (FIG. 2), where N can be any positive integer. Unless specifically recited herein, each of the hoppers 24A, 24B, . . . , 24N will be referred to generally as a hopper 24.

Each hopper 24 can include a plastic, metallic, or other suitable housing that defines an interior compartment that stores coffee beans. For embodiments with more than one hopper 24, at least two of the hoppers 24 can store different coffee beans. The coffee beans in different hoppers 24 can vary by the type/origin of bean, roast level, etc.

As shown in FIG. 2, the hoppers 24 of the hopper assembly 20 can be plumbed into the metering device 18 via a conduit 25, for example, that funnels the coffee beans in each hopper 24 to a respective dispenser 27. Thus, for embodiments including a plurality of hoppers 24, an outlet of each hopper 24 can be plumbed into an inlet of a respective, independently-controllable dispenser.

“Plumbing” one component to another can involve establishing communication between the plumbed components to facilitate the transfer of coffee beans (whole or ground) between the two components. Plumbing can involve extending a conduit, duct, trough, slide, or other structure along which the coffee travels between the two components that are plumbed together. According to alternate embodiments, plumbing components together can simply involve establishing an arrangement of a first component relative to a second component into which the first component is plumbed so that coffee dispensed from the first component is received by the second component. The lines connecting the hopper assembly 20 and the metering device 18, as well as the other lines connecting the schematic representation of the components included as part of the apparatus 10 shown in FIG. 1, represent conduits between the components, as described more fully below.

An illustrative embodiment of the dispenser 27, shown in FIG. 3, includes a pivotal dispenser wheel 29 that is pivotally adjusted by an actuator 37 such as a stepper motor, for example, or any other suitable actuator under the control of a control system 26 (FIG. 1). The dispenser wheel 29 defines a plurality of apertures 35 distributed about a circumferential surface of the dispenser wheel 29. As the dispenser wheel 29 is pivotally adjusted, beans from the respective hopper 24 fall under the force of gravity into each apertures 35 that is upward-opening.

A spring-biased guide 39 contacts surplus beans received in the apertures 35 as the dispenser wheel is pivotally adjusted, preventing the surplus beans from being sheared apart and creating debris, while also limiting the quantity of beans in each aperture 35 to a predictable range of beans. The range of beans expected to be received in each aperture 35 varies based on the size of the beans, which is programmed into a non-transitory, computer-readable medium of the control system 26. Thus, the control system can control operation of the actuator 37 to establish a specific degree of rotation of the dispenser wheel 29 to measure a desired quantity of the coffee beans from the respective hopper 24.

The control system 26 can include a non-transitory computer-readable medium, storing computer executable instructions that, when executed by a computer processor provided to the control system 26, causes the control system 26 to execute the control routines described herein.

The metering device 18 is controlled by the control system 26 to measure quantities of the coffee beans received from one of the hoppers 24, or from a plurality of the hoppers 24, to be included in a composition of coffee beans specified in a coffee order received by the control system 26. Each coffee order can be personalized to include a specific composition of coffee beans desired by the person ordering the coffee. Embodiments of the composition can include: a single type, or a combination of at least two different types of coffee beans (e.g., one or more origins such as Hawaiian Kona, Ethiopian, Brazilian, Kenyan, etc.); a specific roast (e.g., dark, medium, or light) for at least one, and optionally a different roast for at least two different coffee bean types; a desired fraction of one or more different bean types and/or roasts; or any combination thereof.

The control system 26 controls operation of the metering device 18 to measure the specified quantity of each type of coffee bean received from the respective hopper 24. An outlet of the metering device 18 can optionally be plumbed into an inlet of a grinder 28 and/or a degassifier 32 (FIG. 1). The metering device 18 can combine the measured quantities of the requested coffee beans together into the coffee composition, and discharge the coffee composition to be delivered to the grinder 28 according to embodiments that produce ground coffee for a coffee brewing process. Thus, the coffee composition can be supplied to the grinder and/or degassifier 32 by the metering device 18 automatically, without requiring manual intervention to physically transport the coffee composition.

The grinder 28 includes an inlet aperture in communication with an outlet aperture of the metering device 18 via a conduit 30 to receive the coffee composition output from the metering device 18. The grinder 28 can be a flat or conical burr grinder, for example, controlled by the control system 26 or otherwise operated to grind the coffee beans into ground coffee. For example, a distance separating burrs of the grinder 28 can optionally be adjustable to provide the ground coffee with a suitable fineness. The fineness of the ground coffee can be specified by the received coffee order, or can be determined based on information included in the received coffee order such as a desired intensity or strength of the coffee to be brewed in fulfillment of the coffee order. According to alternate embodiments, the fineness of the grind can be manually adjustable.

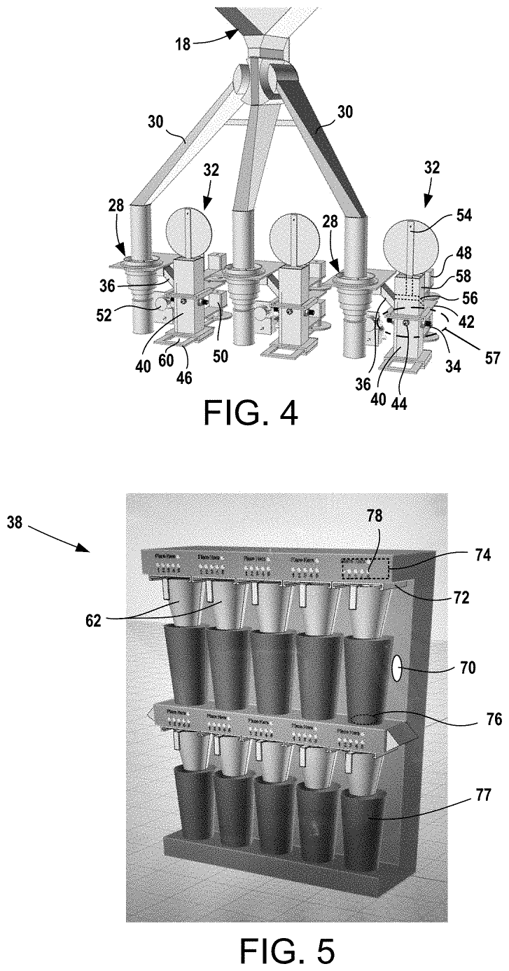

For embodiments that produce ground coffee for a coffee brewing process, a degassifier 32 receives the ground coffee produced by the grinder 28 through a conduit 36 or directly from the grinder 28, for example. A nozzle 34 (FIG. 4) or other emitter sprays water or other liquid droplets into a pathway along which ground coffee from the grinder 28 passes on the way to the degassifer 32, as the ground coffee is being supplied to the degassifier 32. The droplets of water or other liquid can be fine, to create a mist or a fog through which a substantial portion, or nearly all of the ground coffee passes.

The nozzle 34 can be positioned adjacent to a location where the ground coffee exits the grinder 28, to introduce moisture to the ground coffee to produce ground and moistened coffee before the ground and moistened coffee is delivered to a product dispenser 38, where the ground coffee is collected for use. The water used to moisten the coffee grounds discharged by the grinder 28 can be room temperature, or at a temperature lower than a temperature of hot water used for the coffee brewing process (e.g., less than 195° F.). As a specific example, the nozzle 34 can be installed to emit moisture into the conduit 36 extending between the grinder 28 and the degassifier 32. According to alternate embodiments, the nozzle 34 can be installed to emit moisture that the ground coffee is exposed to as the ground coffee enters the degassifier 32 or vacuum chamber 40.

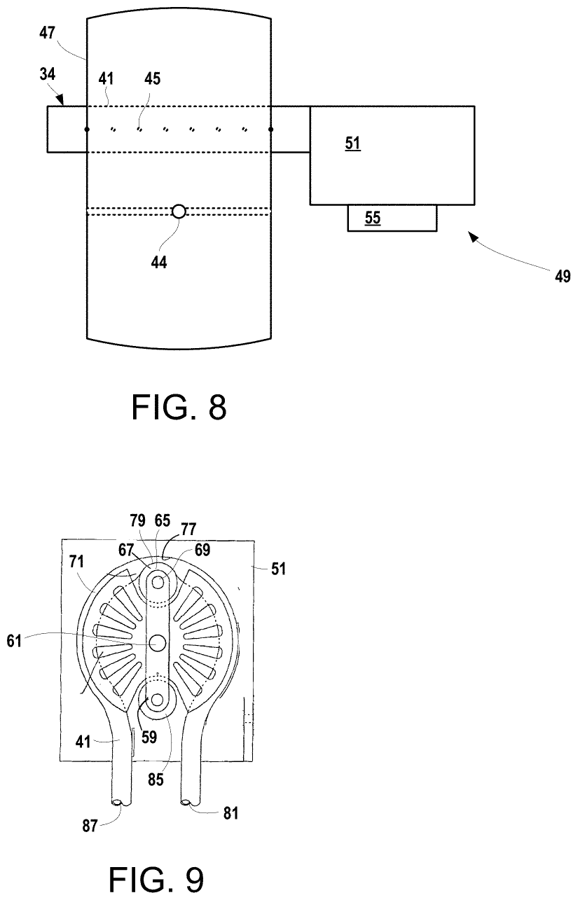

FIG. 8 shows an illustrative embodiment of a portion of a degassifier 32 enclosed by an oval 57 in FIG. 4. The portion of the degassifier 32 within the oval 57 is enlarged in FIG. 8 to illustrate an embodiment of the nozzle 34. Whole-bean or ground coffee exiting the conduit 36 is exposed to moisture while traveling to the vacuum chamber 40. For example, the embodiment of the nozzle 34 in FIG. 8 includes an elongate conduit such as a tube 41 that wraps at least partially about an exterior surface 47 of a conduit leading into the vacuum chamber 40. A portion of the tube 41 hidden by the portion of the degassifier 32 in FIG. 8 is shown in broken lines. A plurality of holes 45 formed in the tube 41 are in fluid communication with apertures formed in the exterior surface 47, allowing water sprayed from the tube 41 through the holes 45 to enter the portion of the degassifier 32 leading into the vacuum chamber 40. The holes 45 can be spaced apart from each other and formed about a substantial portion of the exterior surface 47. For example, the holes 45 can be formed in a region of the tube 41 that extends at least half way about the exterior surface.

A water pump 49 receives water from an external source and is operable to inject the water through the tube 41, out of the holes 45, and into the portion of the degassifier 32 leading into the vacuum chamber 40. The water pump 49 can include any flow-inducing structure that is capable of metering small doses of water into the interior of the portion of the degassifier 32 leading into the vacuum chamber 40.

An illustrative example of the pump 49 in FIG. 8 includes a peristaltic pump that comprises a pump chamber 51 and a motor 55. FIG. 9 is a top, partially cutaway view of an embodiment of the pump chamber 51 of a peristaltic pump. A rotor 59 is coupled to a drive axle 61, which is rotated by the motor 55 to pivotally adjust the rotor 59 about a rotational axis of the drive axle 61. At least one, and optionally a plurality of distal ends 65 of the rotor 59 support a roller 67 that is allowed to rotate about a pin 69. A portion of the tube 41 is received within an arcuate channel 71 defined by an interior surface 77 of the pump chamber 51. As the rotor 59 is pivotally adjusted about the rotational axis of the drive axle 61 an external surface of at least one roller 67 travels along a portion 79 of the tube 41 within the arcuate channel 71, compressing the portion 79 of the tube 41 and thereby restricting the interior diameter of the portion 79 of the tube 41, essentially pinching the portion 79 of the tube 41 closed, or nearly closed to fluid flow (e.g., closing the portion 79 of the tube to a greater extent than the tube 41 in an uncompressed state). As the roller 67 continues to roll along the tube 41, the position of the pinch point moves generally toward an outlet port 81 of the tube 41, creating positive displacement of a quantity of water in the tube 41 toward the outlet port 81. As the rotor 59 continues to rotate, another roller 85 or the roller 67 makes contact with the tube 41 adjacent to the inlet port 87, pinches the tube 41, and urges another quantity of water toward the outlet port 81.

The peristaltic pump is an example of a pump that can precisely regulate the flow of water through the tube 41, and deliver small quantities of water to avoid over saturating the coffee, possibly causing the coffee to aggregate into clumps. For example, an example of the moisture content of coffee after roasting can be within a range from approximately 1.5% to approximately 2.2% by weight. “Approximately” in the sense of moisture content of the coffee and quantities of water can include variances of up to ±25%, or variances of up to ±15%, or variances of up to ±10%. A sufficient quantity of water can be introduced into the degassifier 32 to increase the water content of the coffee up to an elevated range from approximately 2.5% to approximately 3.5%. As a specific example, the water content of the coffee can be elevated to approximately 3% following exposure to the water within the degassifier 32.

To achieve such a small increase in water content, the peristaltic pump can introduce a quantity of water into the portion of the degassifier 32 of approximately 1.9% of the amount of coffee to be degasified, by weight, according to some embodiments. In other words, the amount of water to be introduced according to such embodiments is approximately 1.9% of the weight of the coffee to be degasified. For example, to degas approximately 18 g of coffee (whole bean or ground), approximately 0.342 g of water (i.e., 18 g coffee×0.019) is to be introduced into the portion of the degassifier 32 leading into the vacuum chamber 40, so the coffee travels through the water introduced into the degassifier 32 en route to the vacuum chamber 40. For such embodiments, introducing excess quantities of water can have a detrimental impact on the taste of brewed coffee made using such whole or ground coffee, while introducing an insufficient amount of water may not result in sufficient degasification of the coffee to allow for airtight packaging and/or immediate consumption after degassing is complete.

Regardless of the specific installation location of the nozzle 34, each embodiment can expose the ground coffee to the moisture emitted by the nozzle 34 as the ground coffee is in a fluidic state, traveling between the grinder and the degassifier 32. Exposing the ground coffee to the moisture in the fluidic state promotes improved moistening of the ground coffee compared to spraying a settled “mound” of ground coffee with water, which effectively wets only the uppermost coffee grounds exposed at the top of the mound. In other words, most coffee grounds received by the degassifier 32 that settle into a mound of ground coffee have been exposed to the moisture, including the grounds toward the bottom and mid regions of the pile. In contrast, spraying water onto a top of a settled mound of ground coffee directly exposes only those grounds at the top of the mound to the moisture, and relies on gravity to cause any excess moisture to permeate the mound from the top down, resulting in only the uppermost grounds being moistened.

In addition to moistening the ground coffee, alternate embodiments of the degassifier 32 can expose the ground and moistened coffee to a sub-atmospheric pressure (e.g., less than 1 atm or less than 14.7 psia), or vacuum, optionally repeatedly. According to such embodiments, the degassifier 32 includes a vacuum chamber 40 that receives the ground and moistened coffee. Once the ground and moistened coffee is in the vacuum chamber 40, a door or any adjustable partition 42 can be closed to isolate the vacuum chamber 40 from the conduit 36, the grinder 28, or other components of the apparatus 10 upstream of the grinder 28 (e.g., separated from the degassifier 32 by the grinder 28 along the path traveled by the coffee).

The vacuum chamber 40 can include an outlet aperture 60, shown in the embodiment of FIG. 4 as being formed in a downward-facing surface adjacent to a lower end of the vertically-oriented vacuum chamber 40. The outlet aperture 60 is selectively opened and closed through adjustment of a second adjustable partition 46 under the control of the control system 26. The second adjustable partition 46 can optionally be provided to isolate the interior of the vacuum chamber 40 where the sub-atmospheric pressure is established from components downstream of the degassifier 32, such as a dispenser 48. When the sub-atmospheric pressure is to be established, the partition(s) 42, 46 can be closed to create a substantially-airtight seal enclosing the vacuum chamber 40. The outlet aperture 60 can oppose, or otherwise be plumbed into an inlet aperture of a receptacle 62 (FIG. 5) provided to the product dispenser 38 such that ground and moistened coffee that has been degassed and expelled from the degassifier 32 is received by the receptacle 62.

Actuators 48, 50 such as stepper motors, linear actuators, pneumatic cylinders, etc. are linked to the partitions 42, 46, respectively, and are controllably by the control system 26. For example, the control system 26 activates the actuator 48 to adjust the partition 42 to a position that opens an inlet aperture leading into the vacuum chamber 40, allowing the ground and moistened coffee to enter the vacuum chamber 40. The control system 26 activates the actuator 48 to close the inlet aperture leading into the vacuum chamber 40, isolating the interior of the vacuum chamber 40 from at least the grinder 28, and allowing the sub-atmospheric pressure to be established within the vacuum chamber 40. The second partition 46 is also closed to maintain the sub-atmospheric pressure within the vacuum chamber 40.

A vacuum system comprising a vacuum source 52 such as a vacuum pump, for example, can be controlled by the control system 26 to establish the sub-atmospheric pressure within the vacuum chamber 40 containing the ground and moistened coffee. Once the sub-atmospheric pressure has been established, a release valve 44 of the vacuum system, the partition 42, or other portion of the vacuum system is operable to return a pressure within the vacuum chamber 40 to a second pressure, that is greater than the sub-atmospheric pressure. For example, the release valve 44 can be opened to allow the pressure in the vacuum chamber 40 to return to the ambient pressure of the apparatus 10, or atmospheric pressure.

The sub-atmospheric pressure can optionally be maintained for a suitable period of time to achieve the accelerated degasification, and/or repeatedly established and released within the vacuum chamber 40 for a plurality of cycles. For example, the vacuum source 52 can be selectively operated at defined intervals to establish the sub-atmospheric pressure, with at least one release of the sub-atmospheric pressure in between. As a specific example, five (5), three-second vacuum pulses can be repeatedly applied to the ground coffee within the vacuum chamber 40, with a one second pause between pulses. The release valve 44 can optionally be actuated or otherwise operated to release the sub-atmospheric pressure established by each vacuum pulse in between each such vacuum pulse.

Exposing the ground coffee to at least the moisture emitted by the nozzle 34 in advance of being received in a receptacle such as a filter basket, in which the ground and moistened coffee is to be showered with hot water during a coffee brewing process, is believed to accelerate degassing. Degassing, as used herein, refers to removal of carbon dioxide and possibly other gaseous components retained by the ground and moistened beans, to limit undesirable effects on the taste of the resulting brewed coffee. Accelerated degassing by exposing the ground coffee to the moisture is believed to accelerate the process of removing the retained carbon dioxide and/or other gaseous components by at least 50% relative to allowing the ground coffee to rest at room temperature and pressure (e.g., 70° F., 1 atm.).

Further, it is believed that exposing the ground and moistened coffee to the sub-atmospheric pressure, at least once or optionally repeatedly, accelerates degassing by at least 50% relative to allowing the ground coffee to rest at room temperature and pressure (e.g., 70° F., 1 atm.), or by at least 60%, or by at least 70%, or by up to 90%. The sub-atmospheric pressure can be established, optionally repeatedly, to achieve a latent carbon dioxide retention by the ground and moistened coffee after degassing that can optionally be less than 30 mL per 20-gram dose, less than 20 mL per 20-gram dose, less than 15 mL per 20-gram dose, or less than 10 mL per 20-gram dose of the ground coffee dispensed from the vacuum chamber 40.

Exposing the ground and moistened coffee to the sub-atmospheric pressure within the vacuum chamber 40 is performed independently of any packaging process, which packages the ground and moistened coffee for retail or wholesale sales. For example, the ground and moistened coffee can optionally be showered with hot water during a coffee brewing process as described herein without being packaged for retail or wholesale distribution between a time when the coffee is ground and a time when the ground and moistened coffee is showered with the hot water during the coffee brewing process.

Due to the moisture, however, some of the ground and moistened coffee may adhere to surfaces such as the walls of the vacuum chamber 40 while entering the vacuum chamber 40. To limit the accumulation of coffee on the walls of the vacuum chamber 40, a plunger 54 (FIG. 4) including a wiper surface 56 (shown in broken lines representing a hidden structure in FIG. 4) is linked to an actuator 58 such as a linear actuator, stepper motor, or pneumatic cylinder. The wiper surface 56 can include an elastically-compressible material coupled to, and extending circumferentially about a distal end of the plunger 54. A footprint of the elastically-compressible material has a shape that is similar to a cross-sectional shape of the interior of the vacuum chamber 40. Accordingly, the wiper surface 56 is compressed against, and travels along an interior periphery of the vacuum chamber 40 as the plunger is inserted into the vacuum chamber 40, thereby “sweeping” the adhered coffee off of the walls of the vacuum chamber 40.

According to alternate embodiments, the wiper surface 56 can be formed from a substantially rigid material instead of an elastically-compressible material. According to such embodiments, the wiper surface 56 can also be shaped to closely approximate the interior periphery of the vacuum chamber 40. Rather than deforming in response to coming into contact with the interior periphery of the vacuum chamber 40, the present embodiment of the wiper surface 56 can scrape against the interior periphery of the vacuum chamber 40, thereby removing the ground and moistened coffee.

The control system 26 controls operation of the actuator 58 to urge the plunger 54, and the wiping surface 56, into the interior of the vacuum chamber 40, thereby scraping a portion of the ground and moistened coffee from a wall of the interior passage leading into the vacuum chamber 40, or from the wall of the vacuum chamber 40 itself. Removing the residual ground and moistened coffee from the walls of the vacuum chamber 40 and/or conduit leading into the vacuum chamber 40 can occur after each use of the vacuum chamber, or after a predetermined number of uses of the vacuum chamber 40. For example, the partition 46 adjacent to a lower region of the vertically-oriented vacuum chamber 40 can be adjusted to an open position, allowing the residual coffee scraped from the interior periphery of the vacuum chamber 40 to fall into a waste receptacle under the force of gravity, or otherwise expelled from the vacuum chamber 40.

The vacuum chamber 40 (or the conduit where the ground coffee is moistened by the nozzle 34 for embodiments that lack a vacuum chamber 40) is in communication with the product dispenser 38. A receptacle 62, shown as a filter basket in FIG. 5, is provided to the product dispenser 38. For example, the product dispenser 38 can support the receptacle 62, or otherwise transport or control the discharge of the ground and moistened coffee that exits the degassifier 32 (or conduit with the nozzle 34) into the receptacle 62. Although the receptacle 62 is shown as a filter basket in FIG. 5, other embodiments of the receptacle 62 include, but are not limited to a portafilter, paper filter, French press, or simply a container that can be manually carried from the apparatus 10 to a separate coffee brewing machine that showers the collected coffee with hot water.

The foregoing description involves grinding the coffee beans measured by the metering device 18. However, alternate embodiments of the apparatus 10 involve the accelerated degasification of whole coffee beans by exposing the whole coffee beans measured by the metering device 18 to at least the moisture created by the nozzle 34, and optionally a sub-atmospheric pressure within the vacuum chamber 40. According to such embodiments, the metering device 18 can be plumbed into the degassifier 32 in a manner that bypasses the grinder 28. For example, an optional bypass conduit 64 (FIG. 1) can be installed between the metering device 18 and the degassifier 32.

The whole coffee beans, once moistened, are subsequently received within the vacuum chamber 40 through an inlet aperture that is selectively closed by the partition 42. The partition 42 is adjusted through operation of the actuator 48 under the control of the control system 26. The vacuum source 52 is activated to establish the sub-atmospheric pressure within the vacuum chamber 40, which is then released through operation of the release valve 44. According to illustrative embodiments, the sub-atmospheric pressure can be established for a predetermined period of time (e.g., 10, 20, or 30-seconds), released to cause the pressure in the vacuum chamber 40 to return to atmospheric pressure for a predetermined period of time (e.g., 10, 20, or 30 seconds). This cycle can optionally be performed once, or repeated for a plurality (e.g., at least 2, at least 3, at least 4, at least 5, etc.) of cycles.

For any of the embodiments, the sub-atmospheric pressure established within the vacuum chamber 40 can be any pressure less than 1 atm. (14.7 psia, or 29.92 inches of mercury absolute). For example, the sub-atmospheric pressure can be a 50% vacuum, which is 0.5 atm. (7.3 psia, or 15 inches of mercury absolute). It is believed that exposing whole bean coffee to such sub-atmospheric pressures within the vacuum chamber 40 can accelerate degassing by at least approximately 20% relative to the degassing rate of whole coffee beans exposed to room temperature and pressure. According to other embodiments, it is believed that at least 70%, or at least 80% or at least 90% of degassing can be achieved in less than 7 hours, instead of 7 days under atmospheric conditions.

An illustrative example of a dispenser 38 is shown in FIG. 5. The illustrated embodiment includes a plurality of supports 72 that each receive the receptacle 62, which is a filter basket in FIG. 5. However, alternate embodiments of the support 72 can cooperate with a portafilter for brewing espresso, a hangar supporting a cloth or paper filter, or simply a shelf on which a reusable container is rested to receive the degassed coffee output by the dispenser 38, optionally without manual user intervention. The degassed coffee from the degassifier 32 is received in the receptacle, ready to be showered with hot water during a coffee brewing process.

Each support can optionally be disposed vertically beneath a brew head 74 that includes a heating coil for elevating a temperature of the hot water to be showered onto the degassed coffee in the receptacle 62. A shower head of the brew head 74 includes a plurality of apertures distributed in pattern to distribute the hot water from the heating element over the degassed coffee in the receptacle 62. Other embodiments of the brew heads can lack separate, independently-controlled heating coils for each brew head 74, for example. For such embodiments, the embodiment of the dispenser 38 including a plurality of brew heads 74 shown in FIG. 5 can include a reservoir storing water that is to be heated and distributed through operation of one or more pumps, and/or one or more control valves to the brew head(s) 74 to be utilized in the coffee brewing process. The water can be heated on demand, in a manner similar to a tankless heater, which heats water as it flows from the reservoir. Alternately, water stored in the reservoir can be heated by a reservoir heating element so the hot water can be dispensed on demand at the suitable temperature for brewing (e.g., at least 195° F.), without requiring supplemental heating upon being supplied by the reservoir.

According to alternate embodiments, the dispenser 38 can optionally include a receptacle sensor incorporated into the support 72. For example, a weight sensor can measure a weight of the receptacle 62 received by the support 72. If the measured weight is less than a lower threshold, the control system 26 can determine that the receptacle is not present, and interfere with the distribution of the degassed coffee from the degassifier 32 to where the receptacle is supposed to be. In contrast, if the measured weight exceeds an upper threshold for a specific receptacle 62, the control system 26 can determine that the receptacle 62 already includes degassed or used coffee, and should not receive new degassed coffee for another coffee brewing process. Based on the presence or absence of available receptacles 62, the control system 26 can select one brew head 74 from among the plurality of brew heads 74 with an available receptacle 62 to receive degassed coffee for a coffee brewing process.

The embodiment of the dispenser 38 including the receptacle sensor ensures the receptacle 62 is present to receive the degassed coffee, whole bean or ground, as part of an automated process. According to such a process, the degassed beans can fall under the force of gravity into the receptacle 62, or be conveyed by a bean conveyor or other transport device to physical transport the degassed coffee to the proper receptacle 62. However, alternate embodiments of the dispenser 38 with multiple brew heads 74 can be a stand-alone system, separate from the apparatus 10. According to such embodiments, the degassed coffee can be output and received within a suitable receptacle 62 for the coffee brewing process to be performed provided to a different dispenser 38. For such an embodiment, the different dispenser 38 can be embodied as simply the partition 46 at the bottom of the vacuum chamber 40, the adjustment of which allows the degassed coffee to fall into the receptacle 62, for example. The receptacle 62 that received the degassed coffee can then be manually transported through user intervention from the apparatus 10 to the dispenser 38 having the plurality of brew heads 74, which operate to shower the degassed coffee with hot water during the coffee brewing process.

The dispenser 38 can optionally include a vessel sensor 76 installed at a location to detect a quality indicative of the presence or absence of a vessel 77 that is to receive a brewed coffee drink beneath a receptacle 62. Even if an available receptacle 62 is present at a brew head 74 to receive the degassed coffee, the control system 26 will prevent or terminate a coffee brewing process during which hot water is showered over the degassed coffee if the vessel 77 is not present. For example, the vessel sensor 76 can be a capacitive sensor, weight sensor, or other suitable sensor to detect the presence of a ceramic, metal or paper coffee mug. If the receptacle 62 is available to receive the degassed coffee, the degassed coffee can be discharged by the dispenser into that receptacle 62. However, the process of showering the degassed coffee in the receptacle 62 is delayed until the vessel sensor 76 detects that the ceramic mug is present. To alert a barista to the need for a mug, a visible indicator 78 such as an LED light, or other visible, audible or other indicator is actuated by the control system 26 to distinguish the corresponding brew head 74 waiting on the mug from those that are adequately equipped.

To streamline the process of receiving coffee orders with the control system, a computer-readable code reader 70 can be provided to the dispenser 38, optionally adjacent to each brew head 74. As orders are placed by consumers, a label bearing a computer-readable code such as a barcode, QR code, RFID tag, etc. can be printed onto a label to be applied onto, printed directly onto, or otherwise applied to a drinking vessel 77 suitable for the ordered beverage. The computer-readable code can encode the desired coffee composition and size (e.g., small, medium, large) of coffee beverage to be brewed, for example. The code reader 70 can use an optical sensor, RFID antenna, etc. to read the computer-readable code associated with the vessel 77 when that vessel 77 is placed adjacent to the brew head 74. The code reader 70 transmits a signal indicative of the code that was read, causing the control system 26 to select the corresponding brew head 74 to perform the coffee brewing process, and control the measurement, grinding and degassing of the coffee composition encoded by the computer-readable code.

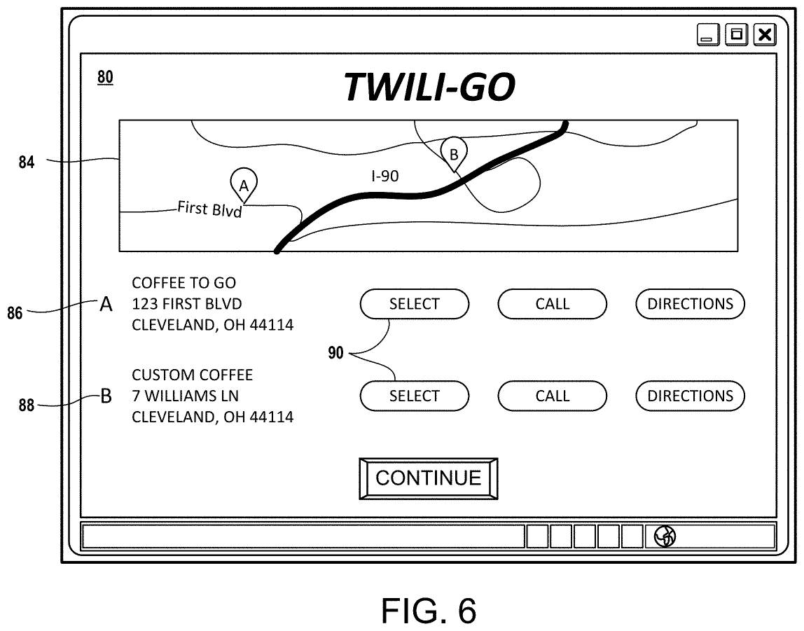

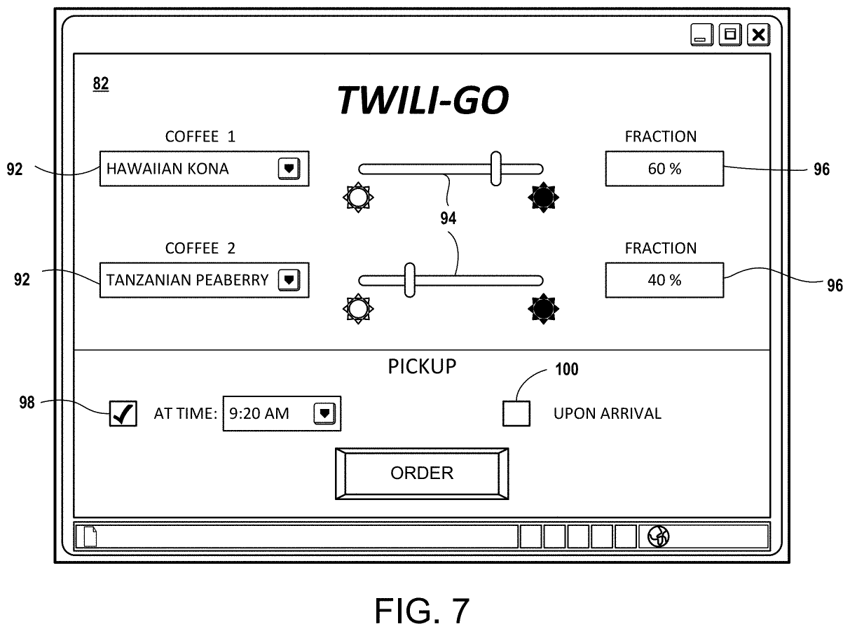

In use, the cellular communication device 14 can execute computer-executable instructions to display a dynamic interface for submitting a coffee order remotely. FIGS. 6 and 7 show illustrative examples of graphical user interfaces (“GUIs”) 80, 82 for submitting the coffee order that is to be received by the control system 26. According to the illustrated embodiments, the GUIs 80, 82 can be displayed by the cellular communication device 14, or another electronic device, executing computer-executable instructions of the coffee ordering app stored in a non-transitory, computer-readable medium.

Using a global positioning system, cellular triangulation, or other location system that can identify the geographic location of the cellular communication device 14, the GUI 80 in FIG. 6 displays nearby café s that offer personalized coffee ordering as described herein. Each option can be displayed visually on a map 84, and in corresponding text entries 86, 88 that are selectable in response to choosing corresponding “SELECT” icons 90.

By selecting one of the SELECT icons 90, a coffee selection currently offered, and optionally in stock at the specific corresponding café can be rendered selectable in the GUI 82 of FIG. 7. Each of the coffee options available for selection can be populated in pull-down menus 92, or other data entry structures that limit the information entered to prevent free text entry. By preventing free text entry, and only listing those coffee options that are available, the coffee selected will be in stock, avoiding unsatisfied customers who may arrive to pick up their coffee only to learn it was not available. If more than one roast level is available, a slider 94 or other entry structure can be rendered selectable (e.g., not grayed out or rendered inactive), allowing the customer to select the type of roast desired. A fractional interface 96 can also be interactive for each selected coffee option, allowing the user to specify the makeup of the coffee composition ordered.

With the coffee composition selected, the user can specify the time at which the coffee is to be picked up at the selected café. A selection 98 such as a checkbox can be utilized to specify an exact, predetermined time when the user would like to pick up the coffee beverage being ordered. As an alternate option, the user can select an option 100 to pickup the coffee beverage ordered whenever the person arrives at the café. For such a selection, the GPS or other location sensing technology of the cellular communication device 14 can be utilized to estimate a time of the user's arrival at the café. Based on environmental factors such as distance from the café, speed limits, known construction zones or traffic or other delays, the cellular communication device 14 or another computer terminal can calculate the approximate time at which the coffee beverage is to be picked up.

For in-café orders, the customer can approach a bar and specify the coffee composition desired to be used to brew the coffee beverage during the brewing process to an employee. According to alternate embodiments, the customer can use a point of sale terminal in the café to manually input the desired coffee composition. A label can be printed bearing the computer-readable code. The employee can apply the label to a suitable mug for the order, and place the labeled mug at an available and ready brew head 74.

The coffee order submitted in any of the above embodiments is received by the control system 26. In response, the control system 26 controls operation of the metering device 18 to retrieve and measure the specific types and quantities of coffee bean included in the coffee composition in the received coffee order. The measured coffee beans of the coffee composition are combined and ground by the grinder 28 to produce ground coffee.

The ground coffee discharged by the grinder 28 is exposed to the moisture from the nozzle 34 while being transported to the degassifier 32, or while being transported to the product dispenser 38 for embodiments that do not expose the ground and moistened coffee to a sub-atmospheric pressure. For embodiments that utilize the vacuum chamber 40, the control system 26 opens the partition 42, allowing the ground and moistened coffee to be received by the vacuum chamber 40. The ground and moistened coffee in the vacuum chamber 40 is exposed to a sub-atmospheric pressure established by the vacuum source 52 at least once, and optionally repeatedly as described herein. Once sufficiently degassed, the partition 46 is opened by the control system 26, causing the degassed coffee to be discharged from the vacuum chamber 40 and transported to the product dispenser 38, where the degassed coffee is introduced to the receptacle 62.

For embodiments that utilize the multiple brew heads 74 shown in FIG. 5, the control system 26 selects the appropriate brew head 74 based on a signal from one or more sensors indicating that the receptacle 62 is available and the drinking vessel 77 is in place. The control system 26 initiates the showering of the degassed coffee in the receptacle 62 to brew the coffee beverage corresponding to the coffee composition that was ordered.

The description above focuses on operation of the apparatus 10 to accelerate the degassing of coffee for consumption or distribution in a café. However, according to alternate embodiments, the apparatus 10 is operable to accelerate the production and packaging of coffee for retail and/or wholesale distribution. Packaging processes for coffee commonly require a package (e.g., bag or other container) to include a valve that allows gasses emitted by roasted coffee beans to be vented from the package. The valve avoids forming an airtight seal of the package, which prevents the package from breaking open as a result of building pressure within the package from the gasses being that continue to be emitted within the package. However, the valve can form a costly portion of the package, and constitutes a weak point of the package through which outside air can possibly enter the package. Further, since the package is not airtight, the flavor profile of the coffee can degrade over time, limiting the shelf life of the packaged coffee during which the coffee retains a pleasing taste and/or aroma, when used during a coffee brewing process.

According to the present method, whole bean and/or ground coffee is degassed through exposure to at least the moisture from the nozzle 34, and optionally the sub-atmospheric pressure in the vacuum chamber 40 as described herein. This accelerated degassing is performed to remove a sufficient quantity of the gas that would otherwise be emitted by the coffee over time within a hermetically-sealed package to prevent expansion of the sealed package to an extent that it bursts open. For example, at least 50%, or at least 60%, or at least 70%, or at least 80%, or at least 90% of the gases such as carbon dioxide, and optionally other gases that remain in the coffee after the roasting process, can be removed by the accelerated degassing process herein.

The degassed coffee can be discharged from the apparatus 10, and subsequently introduced to a packaging system that introduces measured quantities (e.g., ½ lb., 1 pound, 2 pounds, 5 pounds, 10 pounds, etc.) of coffee into each of a plurality of containers sized to receive the quantity of coffee measured for that container. The containers can lack a valve that allows gas to escape the containers, instead being sealable to form an airtight enclosure. A sub-atmospheric (e.g., vacuum) can be established within the containers storing the degassed coffee, and the containers sealed to form the airtight enclosure. Sealing of the packages (which can optionally involve vacuum sealing the packages) according to the present method can optionally be performed within 7 days from a date on which the coffee was roasted, optionally within 5 days from the date on which the coffee was roasted, optionally within 3 days from the date on which the coffee was roasted, optionally within 1 days from the date on which the coffee was roasted, and optionally within 12 hours from a time when the coffee was roasted. By accelerating the degassing of the coffee to be packaged as described herein, the degassed coffee can be sealed in an airtight package, which is believed to extend the shelf life of the packaged coffee, and preserve a flavor profile and aroma of the packaged coffee, when used during a coffee brewing process. Further, selling already-degassed coffee is believed to achieve at least some of the benefits of performing the accelerated degassing described above. Thus, degassed and packaged coffee can be used immediately, and optionally eliminate the need for a pre-infusion step, which many drip coffee machines do not perform, thereby improving the taste of the coffee brewed by such machines compared to the taste of coffee brewed using packaged beans that have not been subjected to the degassing process herein.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for preparing coffee grounds for a coffee brewing process, the apparatus comprising:
a control system that receives a coffee order, the coffee order comprising information indicative of a composition of coffee beans ordered, and a quantity of the coffee beans to be included in the composition;
a metering device that receives the coffee beans from a hopper assembly and is controlled by the control system to: measure the quantity of the coffee beans to be included in the composition, and output the quantity of the coffee beans measured from an outlet aperture;
a grinder comprising an inlet aperture in communication with the outlet aperture of the metering device, wherein the inlet aperture of the grinder receives the measured quantity of the coffee beans output from the outlet aperture of the metering device and grinds the coffee beans to produce ground coffee;
a nozzle that introduces moisture to the ground coffee produced by the grinder, producing ground and moistened coffee;
a vacuum chamber that receives the ground and moistened coffee; and
a vacuum system comprising a vacuum source that is controlled by the control system to generate a sub-atmospheric pressure within the vacuum chamber including the ground and moistened coffee, before the vacuum system returns a pressure to which the ground and moistened coffee in the vacuum chamber is exposed to a second pressure that is greater than the sub-atmospheric pressure.

2. The apparatus of claim 1, wherein the control system receives the coffee order over a communication network from at least one of a point-of-sale terminal and a mobile electronic device.

3. The apparatus of claim 1, wherein the composition of the coffee beans comprises a blend of a plurality of different types of coffee beans, and the quantity of the coffee beans comprises an amount of each of the different types of coffee beans to be included in the composition.

4. The apparatus of claim 1, wherein the metering device comprises a rotatable dispenser structure, comprising a plurality of apertures formed about an exterior periphery of the dispenser structure.

5. The apparatus of claim 4, wherein the control system is programmed with computer-executable instructions to control a number of the apertures that are to receive the coffee beans based on a size of the coffee beans.

6. The apparatus of claim 1, wherein the metering device is plumbed to the hopper assembly to receive the coffee beans from the hopper assembly, and the outlet aperture of the metering device is plumbed to the inlet aperture of the grinder so the quantity of the coffee beans measured by the metering device is dispensed into the grinder without manual intervention to transport the quantity of the coffee beans measured by the metering device to the grinder.

7. The apparatus of claim 1, wherein:
the hopper assembly comprises a plurality of hoppers, each storing a different type of coffee bean,
the metering device comprises a plurality of independently-controlled meters in communication with the plurality of hoppers to separately measure quantities of each of the different types of coffee bean to be included in the composition, and
the quantities of each of the different types of coffee bean measured by the plurality of meters are combined to be ground by the grinder.

8. The apparatus of claim 1, wherein the nozzle is positioned to introduce water droplets into an interior passage between the grinder and the vacuum chamber, to moisten the ground coffee as the ground coffee travels between the grinder and the vacuum chamber.

9. The apparatus of claim 8 further comprising a plunger including a wiper surface that scrapes a portion of the ground and moistened coffee that adheres to a wall of the interior passage into the vacuum chamber.

10. The apparatus of claim 1 further comprising a partition that is adjustable to selectively close an inlet leading into the vacuum chamber, wherein the control system adjusts the partition to close the inlet to isolate the sub-atmospheric pressure within the vacuum chamber from the grinder.

11. The apparatus of claim 1, wherein the vacuum source is controlled to repeatedly establish and release the sub-atmospheric pressure within the vacuum chamber.

12. The apparatus of claim 1, wherein an outlet aperture of the vacuum chamber is in communication with an inlet aperture of a receptacle that receives the ground and moistened coffee dispensed from the vacuum chamber following exposure to the sub-atmospheric pressure, to be showered with hot water during a coffee brewing process without being packaged for retail distribution between a time when the coffee is ground and a time when the ground and moistened coffee is showered with the hot water.

13. The apparatus of claim 1 further comprising a plurality of brew heads, the brew heads being in communication with an outlet aperture of a plurality of vacuum chambers for receiving the ground and moistened coffee that has been exposed to the sub-atmospheric pressure within the vacuum chamber, wherein the control system selects a first brew head from among the plurality of brew heads to receive the ground and moistened coffee, and controls the first brew head to shower the received ground and moistened coffee with hot water during the coffee brewing process.

14. The apparatus of claim 13 further comprising a sensor, in communication with the control system, that senses a presence of a vessel at the first brew head to receive brewed coffee during the coffee brewing process, and causes the control system to interfere with the coffee brewing process when the vessel is not present at the first brew head.

15. The apparatus of claim 13 further comprising a visible indicator that is controlled by the control system to distinguish the first brew head from another one of the plurality of brew heads.

16. The apparatus of claim 13 further comprising a code reader in communication with the control system, wherein the code reader reads a computer-readable code associated with a vessel that is to be positioned at the first brew head to receive brewed coffee produced by the coffee brewing process, and the control system selects the first brew head in response to the computer-readable code being read by the code reader.

17. The apparatus of claim 16, wherein the control system receives the coffee order in response to the computer-readable code being read by the code reader.

18. The apparatus of claim 1 further comprising a filter that receives the ground and moistened coffee dispensed, wherein the filter supports the ground and moistened coffee during the coffee brewing process.

19. An apparatus for preparing coffee beans for a coffee brewing process, the apparatus comprising:
a control system that receives a coffee order comprising information indicative of a quantity of the whole coffee beans to be included in the coffee order; and
a degassifier comprising:
a nozzle that introduces moisture to the whole coffee beans included in the coffee order, producing moistened coffee beans, wherein the degassifier exposes the moistened coffee beans to a sub-atmospheric pressure after introduction of the moisture to the whole coffee beans to produce degassed whole coffee beans, and
a dispenser that discharges the degassed whole coffee beans to a packaging system to be packaged for distribution as degassed packaged coffee.

20. The apparatus of claim 19, wherein the degassifier extracts a sufficient quantity of gas from the moistened coffee beans so the degassed whole coffee beans are discharged from the dispenser in a condition suitable for packaging in an airtight container that lacks a valve allowing gas to escape the container.
